(19) United States
(12) Patent Application Publication
(10) Pub. No.: US 2014/0189544 A1
(43) Pub. Date: Jul. 3, 2014

(54) WEB-BASED GRAPHICS DEVELOPMENT SYSTEM AND METHOD OF GRAPHICS PROGRAM INTERACTION THEREWITH

(71) Applicant: NVIDIA CORPORATION, Santa Clara, CA (US)

(72) Inventors: Cass Everitt, Austin, TX (US); Nigel Stewart, Austin, TX (US)

(73) Assignee: NVIDIA CORPORATION, Santa Clara, CA (US)

(21) Appl. No.: 13/728,235

(22) Filed: Dec. 27, 2012

(51) Int. Cl. G06F 3/048

(52) U.S. Cl. CPC G06F 3/048
USPC 715/760

(57) ABSTRACT

A web-based graphics development system for developing a graphics application and a method of debugging a graphics application. One embodiment of the graphics development system includes: (1) a web server application configured to host at least one graphics library and linkable to the graphics application, and (2) a client configured to gain access to and interact with the graphics application through a web browser application couplable to the web server application over a network.

### TECHNICAL FIELD

This application is directed, in general, to graphics development and, more specifically, to web-based graphics development tools.

### BACKGROUND

Software development is carried out in a variety of integrated development environments (IDEs) supporting numerous programming languages and for a vast array of applications. A developer's decision on which IDE to use is largely driven by the application and ultimately the intended target platform.

Many applications demand specific target platforms, such as a single board computer (SBC) running a real-time operating system (RTOS) or a personal computer (PC) running a Linux® operating system (OS). Other applications focus more on ease of use and portability across many platforms, otherwise known as cross-platform compatibility. The developer is therefore tasked with selecting a particular IDE that suits not only the application, but the target platform.

Another consideration made by developers, and more often their employers, is the available development platform and peripheral tools. It is unreasonable for a developer to procure a dedicated development platform for each new application. Developers tend to bind to the development tools and resources they have used in the past and currently have, again potentially forcing the hand of the developer. The inflexibility of available tools to support the necessary target platforms and applications unnecessarily restricts the developer and the application that results.

The development platform and the target platform are often different. Under those circumstances, the developer must piece together several development tools with the available IDE. The developer generates source code, manages versions, and tracks progress on the development platform, while validating the design and performance of the target application can only be done once the code is ported over, compiled, linked and executed on the target platform. Such an arrangement is often fragile and complex, creating steep learning curves for developers.

Graphics development is no exception to these conventions. The development tool kits are more specialized and therefore scarce. Furthermore, high-end graphics demand robust target platforms at sometimes exorbitant cost. The graphics development industry continues to rely on dedicated platforms and specialized, often custom, IDEs to develop high-end graphics applications.

### SUMMARY

One aspect provides a graphics development system for developing a graphics application, including: (1) a web server application configured to host at least one graphics library and linkable to the graphics application, and (2) a client configured to gain access to and interact with the graphics application through a web browser application couplable to the web server application over a network.

Another aspect provides a method of debugging a graphics application, including: (1) launching a web server application, the launching including: (1a) linking to a graphics library, and (1b) launching the graphics application, (2) addressing the web server application through a web browser application executing on a client platform, and (3) interacting remotely with the graphics application through the web browser application.

Yet another aspect provides a graphics development system for developing a graphics application, including: (1) a web server application configured to execute on a target platform, having: (1a) a hypertext transfer protocol (HTTP) server couplable to a network, (1b) a plurality of linkable graphics libraries, and (1c) a debugging environment operable to launch the graphics application, and (2) a client platform couplable to the network, operable to execute a web browser application, the web browser application operable to: (2a) communicate with the HTTP server, (2b) gain access to the debugging environment, and (2c) interact with the graphics application.

### BRIEF DESCRIPTION

Reference is now made to the following descriptions taken in conjunction with the accompanying drawings, in which:

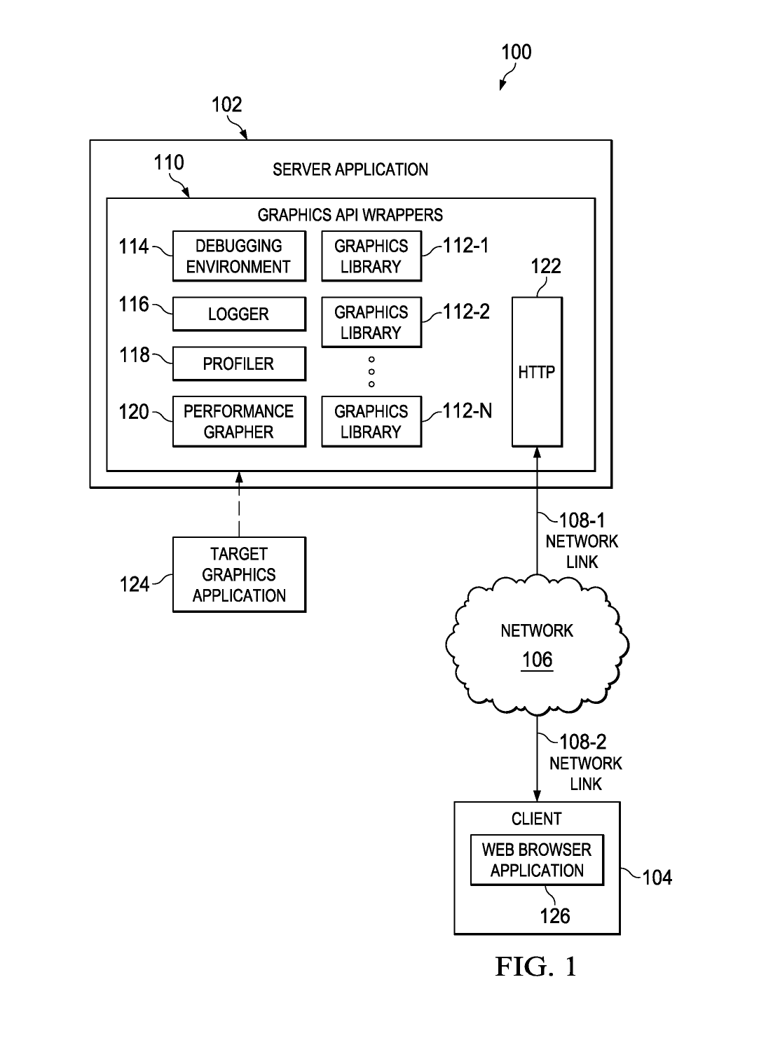

FIG. 1 is a block diagram of one embodiment of a graphics development system;

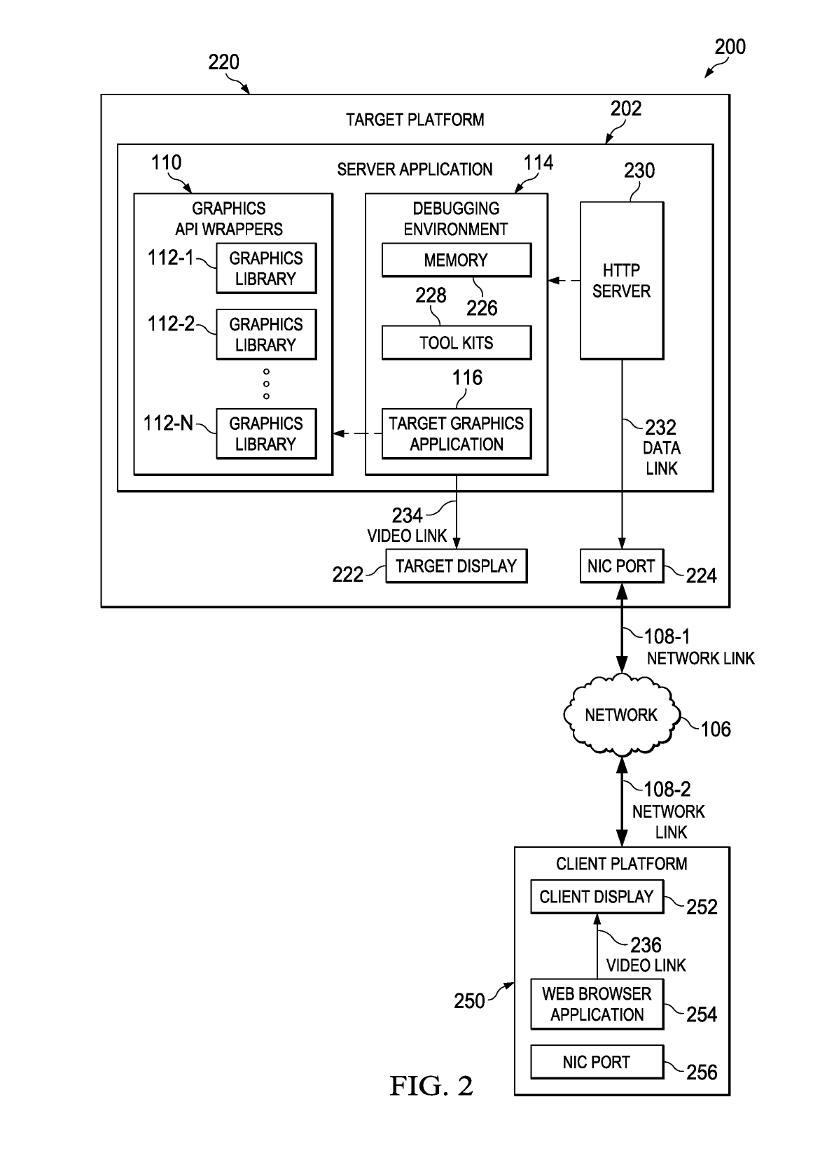

FIG. 2 is a block diagram of another embodiment of a graphics development system; and

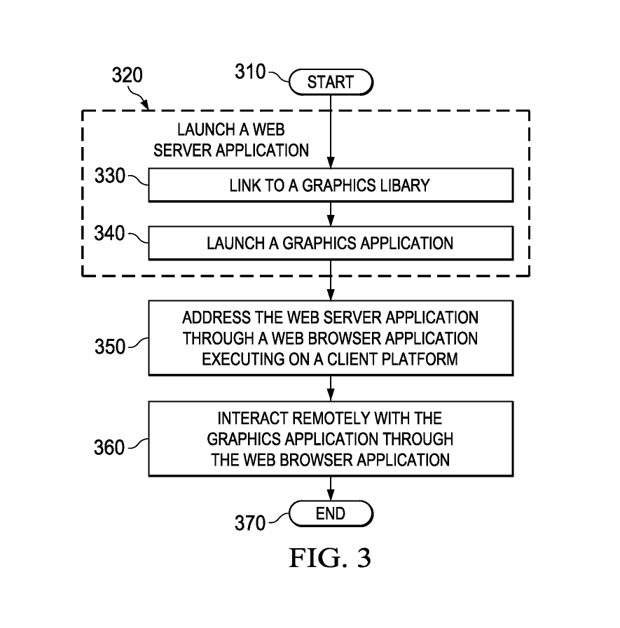

FIG. 3 is a flow diagram of one embodiment of a method of debugging a target graphics application.

### DETAILED DESCRIPTION

Before describing various embodiments of the graphics development system or method of debugging introduced herein, graphics development environments will be generally described.

A graphics development environment is a specialized software IDE. An IDE generally includes a source code editor, build automation tools and a debugger. Common to many development environments, a graphics debugger allows the developer to inspect the execution of the target graphics application, both graphically and numerically. Developers often need to see timing profiles for certain processes and sometimes call stacks for others. The most basic inspection for graphics applications is of rendered images, for which many graphics debuggers provide a viewing window. High-end graphics processing is finely tuned and susceptible to perceptible glitches and latency. The graphics development environment is an avenue for the developer to create, test, and achieve a finely tuned target graphics application. The variety of tool kits available in a debugging environment allows the developer to work effectively and efficiently.

The debugging environment allows the target graphics application to execute in a controlled, meaningful fashion. This generally requires the graphics application to execute within the debugging environment and on the target platform, as opposed to some other development platform. Consequently, a discontinuity develops between the developer and the graphics application executing in the debugging environment. The discontinuity is often overcome by specialized development software that executes on the development platform and the target platform while maintaining a data link between the two.

It is realized herein that the rigidity and complexity of conventional graphics development environments may be overcome by a web-based graphics development environment, adopting a server-client architecture. In the server-client architecture, the target resides on the server side and the development platform on the client side. The link between the two is a network connection. It is further realized herein that the complexity of synchronizing the IDE, source code, and builds between the server and client is eliminated by hosting the entire development from the server and providing a viewing portal to the developer. It is realized herein such a server application may include a full set of graphics development tools (e.g., build tools, profiler, debugger) in addition to hypertext transfer protocol (HTTP) server capability. It is realized herein that the graphics development environment may execute on the target platform and be capable to build and launch the graphics application.

It is also realized herein the graphics APIs may be further integrated into the development environment by providing an additional software wrapper layer on the core APIs. It is further realized herein the graphics development environment may be integrated into graphics API wrappers that are ultimately linked, compiled and exercised by the graphics application. It is realized herein the graphics API wrappers may include HTTP functionality such that the capabilities of the graphics development environment are built into the graphics application and client need only gain access via a network connection. It is realized herein such additions greatly improve the usability of the API and the efficiency of the development.

It is fundamentally realized herein that the developer requires no more than a web browser to assume the client role. It is realized herein a client need only basic web browsing capability plus support for hypertext markup language (HTML), Extensible Markup Language (XML), Javascript®, Asynchronous JavaScript® and XML (AJAX), or any other mature web technology to be effective. It is fundamentally realized herein that the portability of such a graphics development system extends to all (HTML) compatible web browsers, including nearly all web-enabled devices such as tablets and other mobile devices, desktop and laptop PCs, and virtually all modern operating systems.

It is further realized herein that a designer or customizer of a graphics development environment may relay as much or as little data as is necessary to suit the development. It is realized herein that beyond appropriate addressing (i.e., internet protocol, or IP, address and port) the developer need only interact with the client as if she were browsing the web.

It is fundamentally realized herein that the flexibility of the graphics development environment is greatly improved by focusing compatibility almost entirely on the target platform and server application, as the developer may use virtually any web enabled platform as the client or development platform. It is realized herein that the server application may be cross-platform compatible, meaning the server application supports many target platforms, including Microsoft® Windows®, Linux®, Mac OS®, Android®, iOS®, and any other conventional or later-developed platform. It is realized herein support for all modern operating systems and graphics APIs may be integrated into the graphics development environment. It is further realized herein that the desired graphics APIs may reside on the server side of the architecture and are therefore linkable through the web browser. The developer need only identify the graphics APIs, such as Open Graphics Library (OpenGL) or DirectX, and software libraries necessary for the graphics application. It is realized herein that the build tools hosted by the server application and through the client web browser eliminate the need to synchronize libraries across development and target platforms.

Having generally described graphics development environments, various embodiments of the graphics development system and method of debugging introduced herein will be described.

FIG. 1 is a block diagram of one embodiment of a graphics development system 100. The system 100 includes a server application 102 and a client 104, each coupled to a network 106 by its respective network links 108-1, 108-2. In certain embodiments the network 106 may be an isolated development network. In other embodiments the network 106 is simply the World Wide Web. In the embodiment of FIG. 1, the server application 102 includes a repository of graphics API wrappers 110, containing one or more graphics libraries 112-1 through 112-N. In alternate embodiments a graphics library 112-n may be a software wrapper on a basic graphics API, such as OpenGL or DirectX. The graphics API wrappers 110 further include development tools including a debugging environment 114, a logger 116, a profiler 118 and a performance grapher 120. Alternate embodiments may include further capabilities such as statistics, browsing, configuring, editing and modifying API behavior. In the embodiment of FIG. 1, the graphics API wrappers 110 include HTTP capability 122.

The client 104 includes a web browser application 126. The web browser application 126 is any browser supporting basic HTML web browsing. In certain embodiments the web browser application 126 also supports more advanced web technologies such as XML, AJAX, or JavaScript®. The web browser application 126 is operable to gain access to the server application 102 via the network 106 and network links 108-1 and 108-2. Once access is had, the web browser application is operable to configure a build for the target graphics application 124 by linking select graphics libraries 112-1 through 112-N from the graphics API wrappers 110.

Once the target graphics application 124 is launched and network access had, a developer, working from the client 104, may establish a debugging session or interact with the target graphics application 124 through the debugging environment 114 or other tools.

FIG. 2 is a block diagram of another embodiment of a graphics development system 200. System 200 includes a target platform 220 and a client platform 250 coupled to network 106 of FIG. 1 by network links 108-1 and 108-2. Target platform 220 includes a server application 202 plus a target display 222 and a network interface controller (NIC) port 224. Server application 202 further includes an HTTP server 230 coupled to NIC port 224 via a data link 232, and consequently coupled to network 106 via network link 108-1.

The debugging environment 114 residing in server application 202 further includes a memory 226 and tool kits 228 in addition to the target graphics application 124. Target graphics application 124 is coupled to target display 222 via a video link 234. In certain embodiments tool kits 228 includes a variety of development tools such as source code editors, build tools, and profiling tools. Other embodiments include a rendered graphics viewer.

Returning to FIG. 2, client platform 250 includes a client display 252 coupled to a web browser application 254 by a video link 236. Client platform 250 further includes a NIC port 256 coupled to network link 108-2, through which client platform 250 communicates to network 106 and ultimately target platform 220.

In alternate embodiments client platform 250 can be a variety of computing platforms, including tablet computers and other web enabled mobile devices, desktop and laptop PCs, or possibly even a single-board computer. This flexibility of alternate embodiments makes system 200 cross-platform compatible. The flexibility extends to certain embodiments where server application 202 is compatible with a variety of different target platforms 220. One embodiment of server application 202 may be executed on a range of target platforms 220 from desktops running an Microsoft® Windows® operating system to mobile devices running an Android® operating system.

In operation, graphics development system 200 facilitates an interaction among the developer, target graphics application 124 and client platform 250. The developer gains access to debugging environment 114 by addressing HTTP server 230 through web browser application 254 on client platform 250. HTTP server 230 is integrated with server application 102 and maintains a soft link to debugging environment 114 during run-time. Server application 202 is configured to launch debugging environment 114 along with target graphics application 124, target graphics application 124 being built by build tools of tool kits 228 with a linking to graphics API wrappers 110. Target graphics application 124 executes in a controlled environment, utilizing a dedicated memory 226 and tool kits 228.

Interaction is had among the developer, target graphics application 124 and client platform through web browser application 254. HTTP server 230 handles data queries by generated by web browser 254 in response to developer browsing. Data associated with target graphics application 124 as it executes is relayed to web browser application 254 on client platform 250 through the HTTP server 230. In this way, the developer may gain access to tool kits 228 and graphics rendered on target platform 220.

FIG. 3 is a flow diagram of one embodiment of a method of debugging a graphics application. The method begins in a start step 310 and proceeds into a launching phase 320 for the web server application. In the launching phase 320, graphics libraries are linked to the application in a linking step 330, whereby a developer selects the appropriate APIs and software libraries necessary for the graphics application. Next in the launching phase 320, the graphics application is launched in a step 340. In the launching step 340, the graphics application is executed in the debugging environment hosted by the web server application. In certain embodiments, the web server application is executing on a target platform and therefore executing the debugging environment and graphics application on the target platform.

The method of FIG. 3 continues with an addressing step 350 whereby the developer, acting through a web browser executing on a client platform, addresses the web server application. Once addressed, an interacting step 360 is carried out whereby the developer interacts remotely with the graphics application. In the illustrated embodiment, the interacting step 360 is performed through the web browser application on the client platform. The method then ends in an end step 370.

In alternate embodiments, the developer, working on the client side of the architecture, employs a cross-platform compatible client. In other embodiments, the web server application is also cross-platform compatible, capable of supporting most modern operating systems including Microsoft® Windows®, Linux®, MacOS®, Android®, iOS®, and many others. In certain embodiments the server-client architecture is itself cross-platform compatible. Developers may use virtually any web enabled device with an HTML capable web browser to debug a graphics application executing in a debugging environment hosted by the web server application executing on virtually any target platform.

Those skilled in the art to which this application relates will appreciate that other and further additions, deletions, substitutions and modifications may be made to the described embodiments.

What is claimed is:

1. A graphics development system for developing a graphics application, comprising:
a web server application configured to host at least one graphics library and linkable to said graphics application; and
a client configured to gain access to and interact with said graphics application through a web browser application couplable to said web server application over a network.

2. The graphics development system recited in claim 1 wherein said client is operable with cross-platform compatible versions of said web browser application.

3. The graphics development system recited in claim 2 wherein said client is compatible with a Microsoft® Windows® operating system and a Linux® operating system.

4. The graphics development system recited in claim 1 wherein said web server application is configured to be executed on a target platform.

5. The graphics development system recited in claim 4 wherein said web server application is cross-platform compatible.

6. The graphics development system recited in claim 1 wherein said at least one graphics library is a wrapper layer on a graphics application programming interface (API).

7. The graphics development system recited in claim 1 wherein said at least one graphics library is an Open Graphics Library (OpenGL).

8. A method of interacting with a graphics application, comprising:
launching a web server application, said launching including:
linking to a graphics library, and
launching said graphics application;
addressing said web server application through a web browser application executing on a client platform; and
interacting remotely with said graphics application through said web browser application.

9. The method recited in claim 8 wherein said launching is carried out on a target platform.

10. The method recited in claim 9 wherein said web server application is cross-platform compatible.

11. The method recited in claim 8 wherein said client platform is a Microsoft® Windows® operating system.

12. The method recited in claim 8 wherein said interacting is portable among personal computers and mobile devices.

13. The method recited in claim 8 wherein said graphics library is an Open Graphics Library (OpenGL).

14. The method recited in claim 8 wherein said interacting comprises:
querying graphics application data from said web server application, and
presenting said graphics application data in said web browser application for inspection and modification.

15. A graphics development system for developing a graphics application, comprising:
a web server application configured to execute on a target platform, having:
a hypertext transfer protocol (HTTP) server couplable to a network,
a plurality of linkable graphics libraries, and
a debugging environment operable to launch said graphics application; and
a client platform couplable to said network, operable to execute a web browser application, the web browser application operable to:
communicate with said HTTP server,
gain access to said debugging environment, and
interact with said graphics application.

16. The graphics development system recited in claim 15 wherein said web server application is cross-platform compatible.

17. The graphics development system recited in claim 16 wherein said web server application is compatible with a Microsoft® Windows® operating system and a Linux® operating system.

18. The graphics development system recited in claim 15 wherein said target platform is a different operating system than said client platform.

19. The graphics development system recited in claim 15 wherein said plurality of graphics libraries include a wrapper layer on a graphics application programming interface (API).

20. The graphics development system recited in claim 19 wherein said graphics API is an Open Graphics Library (OpenGL).
